(19) United States
(12) Patent Application Publication
(10) Pub. No.: US 2010/0095545 A1
(43) Pub. Date: Apr. 22, 2010

(54) Chalk drawing device and method

(76) Inventor: John Terence Miller, Newport, RI (US)

Correspondence Address: PATENT GROUP;C/O DLA PIPER US LLP, 203 N. LASALLE ST., SUITE 1900, CHICAGO, IL, 60601, US

(21) Appl. No.: 12/587,821

(22) Filed: Oct. 13, 2009

Related U.S. Application Data
(60) Provisional application No. 61/104,936, filed on Oct. 13, 2008.

(51) Int. Cl. G01B 3/10

(52) U.S. Cl. 33/701; 33/759

(57) ABSTRACT

A device for creating a chalk drawing on a surface includes a base adapted to rest on the surface, a housing cover rotatably connected to the base and a direction indicator indicating a rotational position of the housing cover with respect to the base. A tape measure assembly is connected to the housing cover and includes a tape measure that may be moved between extended and contracted conditions. The tape measure includes a distal end portion. A position of the distal end portion of the tape measure and a rotational position of the housing cover with respect to the base establish coordinates for a plot point of the chalk drawing. A method for creating a chalk drawing using the device is also disclosed.

### CLAIM OF PRIORITY

This application claims priority from U.S. Provisional Patent Application Ser. No. 61/104,936, filed Oct. 13, 2008, currently pending.

### FIELD OF THE INVENTION

The present invention generally relates to creative toys for children and, more particularly, to a device and method for plotting and creating chalk drawings.

### BACKGROUND

For many years, children, and even some adults, have enjoyed making drawings on sidewalks, driveways and other paved surfaces, using chalk. The chalk used may be simply white, or a variety of other colors. Such drawings may be simply washed away with water after they are enjoyed for a period of time.

A child's participation and enjoyment in this creative activity, however, has traditionally been limited by the artistic ability of the child. Even if a child is naturally artistic, the ability to create more complex and interesting drawings broadens the appeal of the activity. It is therefore desirable to provide a device and method that enable children to create chalk drawings. Such a device and method should be easy to use and enable a variety of different drawings to be created.

### BRIEF DESCRIPTION OF THE DRAWINGS

FIG. 1 is an exploded perspective view of an embodiment of the chalk drawing device of the present invention;

FIG. 2 is a top plan view of the chalk drawing device of FIG. 1 after assembly;

FIG. 3 is a cross-sectional view of the chalk drawing device of FIG. 2 taken along line 3-3 of FIG. 2;

FIG. 4 is an illustration of a chalk drawing created using an embodiment of the chalk drawing device and method of the present invention;

FIGS. 5 and 6 are front and back side views, respectively, of a recipe card for use with an embodiment of the chalk drawing device and method of the present invention;

FIGS. 7a-7e illustrate the use of the chalk drawing device of FIGS. 1-3 in accordance with an embodiment of the method of the present invention.

### DETAILED DESCRIPTION OF EMBODIMENTS

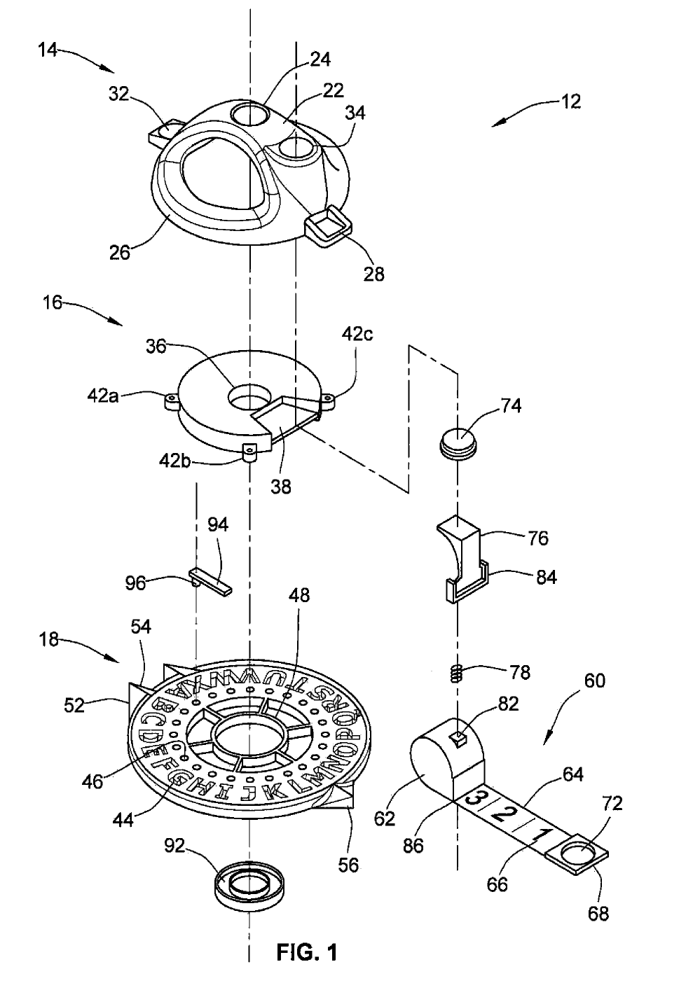

An embodiment of the chalk drawing device is indicated in general at 12 in FIGS. 1-3. As illustrated in FIG. 1, the device includes a housing cover, indicated in general at 14, a mounting plate, indicated in general at 16, and a base, indicated in general at 18. All three components are preferably constructed from molded plastic.

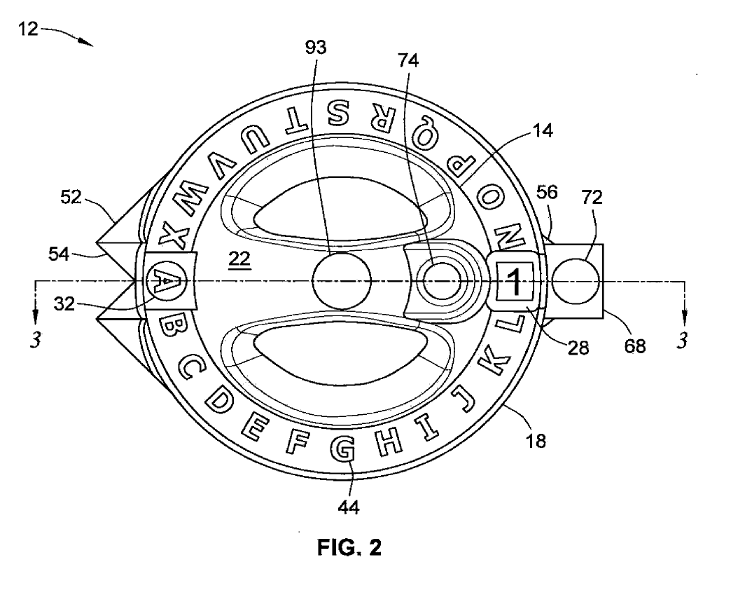

As illustrated in FIGS. 1 and 2, the housing cover 14 includes a handle portion 22 which features a circular central opening 24, the purpose for which will be explained below. The housing portion also includes a rim portion 26 to which is mounted a square tape measure window 28 and a round direction window 32. The housing cover also features a button aperture 34.

With reference to FIG. 1, the mounting plate 16 features a circular central opening 36 and a tape measure recess 38. In addition, four tabs 42a, 42b, 42c and 42d (not shown) are positioned in spaced relation about the circumferential edge of the mounting plate. Each tab features an aperture.

As shown in FIGS. 1 and 2, the base 18 includes letters of the alphabet 44 molded about the circumference. While the letters are illustrated as molded into the base, they may alternatively be printed, attached with adhesive or as stickers, or using other methods known in the art. In addition, in place of letters, as will be apparent from the following description of use, symbols, numbers or other characters could be substituted for the letters as directional characters. Adjacent to and radially inward from each letter is a corresponding circular detent 46. The base also includes a central opening 48, a trailing alignment tab 52 featuring a V-shaped notch 54, and a triangular shaped leading tab 56.

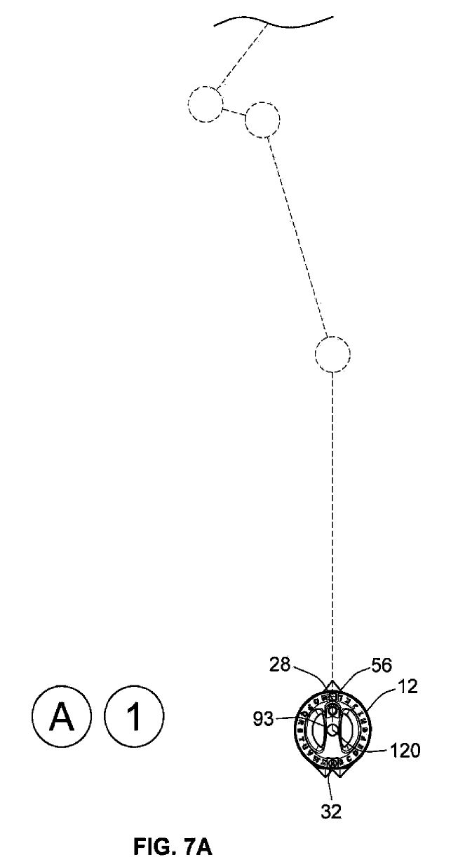

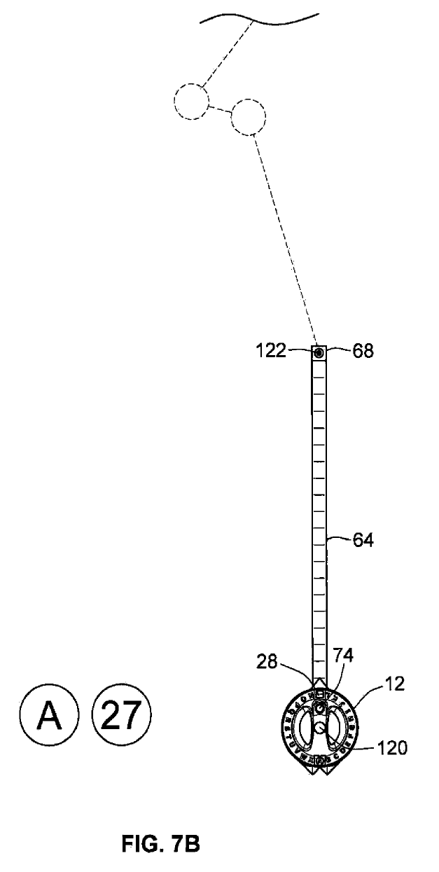

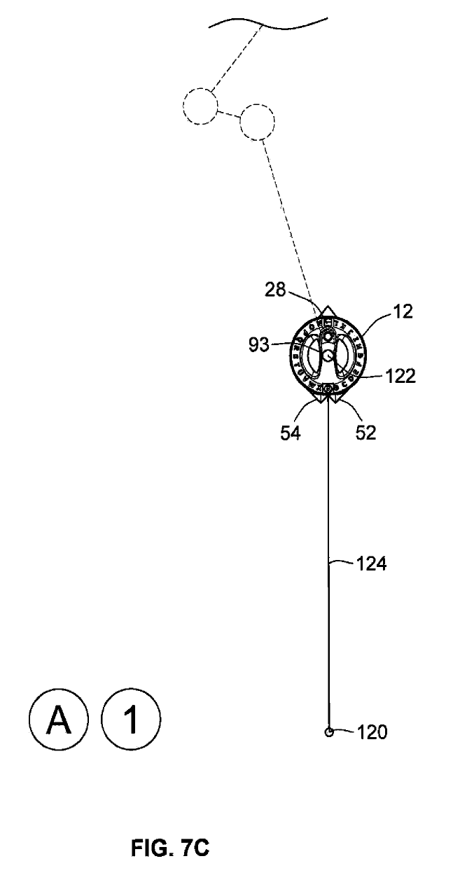

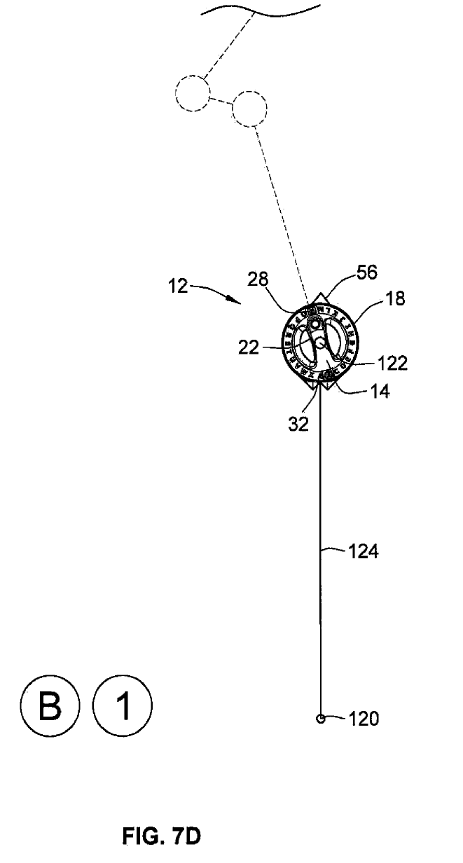

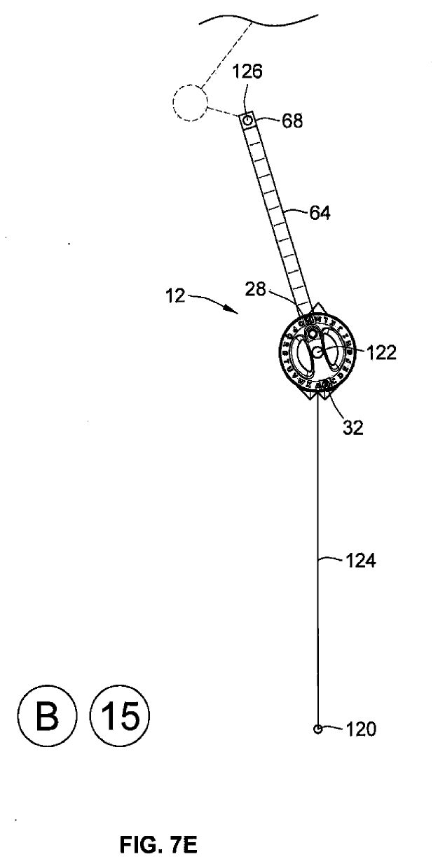

A tape measure assembly, indicated in general at 60 in FIG. 1, features a housing 62 which contains a rolled-up tape measure, a portion of which is indicated at 64. As indicated at 66, the tape measure 64 is provided with numbers or other tape measure characters. The distal end portion of the tape measure is provided with pull tab 68, which features circular opening 72. A coil spring (not shown) is positioned within the housing 62 and is attached to the tape measure 64 and urges it from an extended condition (such as illustrated in FIGS. 1 and 7b) into a retracted condition (such as illustrated in FIGS. 2 and 7a) where it is entirely rolled-up within the housing. Such arrangements are well known in the art and alternative types of springs and arrangements for retracting the tape measure may be used instead.

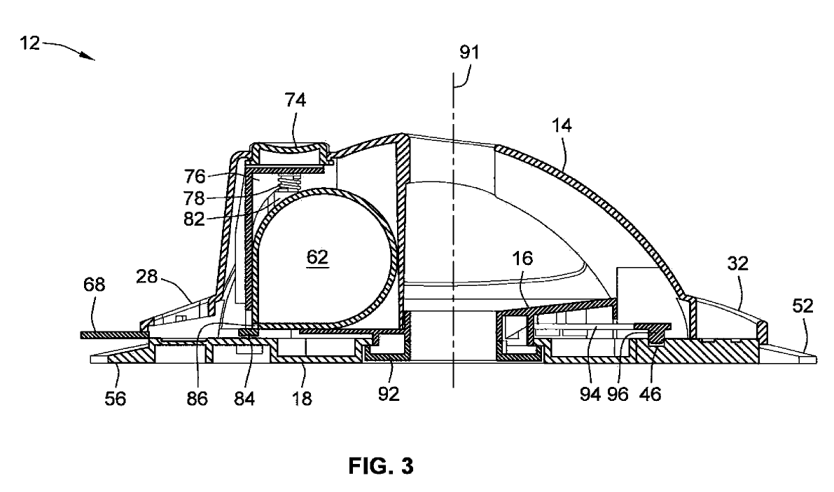

With reference to FIGS. 1-3, during assembly of the device, a tape retraction button 74 is positioned within the button aperture 34 of the handle cover 14. With reference to FIGS. 1 and 3, the tape measure housing 62 is then positioned on the tape measure recess 38 of mounting plate 16 and a tape measure brake 76 and compression coil spring 78 are positioned on top of a ledge 82 molded onto the tape measure housing 62.

The mounting plate 16 is then attached to the bottom of the housing cover 14 via screws or rivets that engage the apertures of tabs 42a -42d (FIG. 1) of the mounting plate and corresponding openings formed in the underside of the housing cover.

With reference to FIGS. 1 and 3, the tape measure brake 76 features a flange portion 84 that abuts the bottom edge 86 of the tape measure housing 62 so that the tape measure 64 (FIG. 1) is pinched there between and prevented from retracting into the housing 62. When the tape retraction button 74 is pressed, it engages the brake 76 so that it is pushed and slides downward, against the upward urging of spring 78. As a result, the flange portion 84 of the brake 76 moves away from the bottom edge 86 of the tape measure housing so that the tape measure 64 is released and automatically retracted into housing 62, and thus the housing cover 14. As illustrated in FIGS. 2 and 3, the pull tab 68 of the tape measure remains exposed so that the tape measure may be extended for future use.

A fastening ring, indicated at 92 in FIGS. 1 and 3, secures the base 18 to the underside of mounting plate 16 through the central opening 48 of the base. The fastening ring 92 may be secured to the mounting plate via threads, adhesive or other fastening arrangements. Base central opening 48 is sized so that the base 18 may rotate with respect to the housing cover 14 and the mounting plate 16 (which is secured to the housing cover as previously described) about a vertical rotational axis indicated at 91 in FIG. 3. The central openings of the housing cover 14, mounting plate 16 and base 18, illustrated at 24, 36 and 48, respectively, in FIG. 1, are aligned to form a circular point viewing window 93 (FIG. 2).

With reference to FIGS. 1 and 3, a ratchet arm 94 features a proximal end that is secured to the underside of mounting plate 16 and a distal end that features a projection 96 that engages the detents 46 of the base. As a result, the housing cover moves incrementally in a ratcheting fashion when it is rotated with respect to the base.

As illustrated in FIG. 2, a letter of the base 18 appears in the direction window 32 of the housing cover 14 to serve as a direction indicator, while a number of the tape measure (64 in FIG. 1) appears in the tape measure window 28. It should be noted that in an alternative embodiment, the device could feature a direction indicator including characters positioned on the housing cover and the direction window positioned on the base.

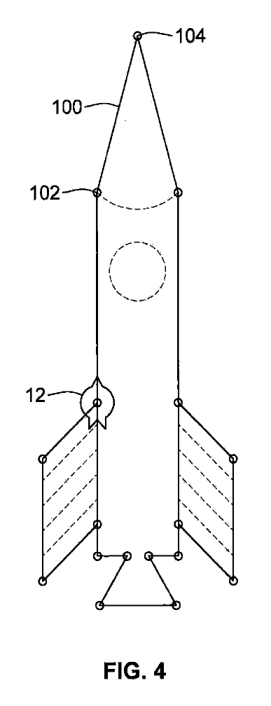

The device 12 of FIGS. 1-3 may be used to create a chalk drawing, such as the one illustrated in FIG. 4, using the following procedure. Notably, as illustrated in FIG. 4, the drawing is made up of a number of line segments, such as the one indicated at 100, that extend between plot points, such as 102 and 104.

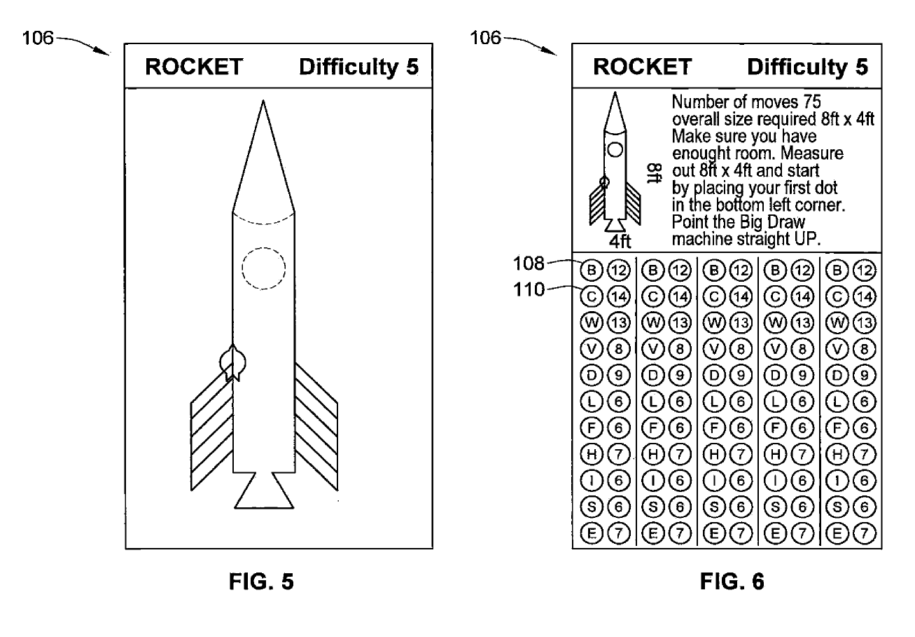

A recipe card, indicated in general at 106 in FIGS. 5 and 6, features a front side (illustrated in FIG. 5) and a back side (illustrated in FIG. 6). As illustrated in FIG. 5, the front side of the card preferably includes an illustration of what the finished drawing will generally look like. As illustrated in FIG. 6, the back side of the card features a series of two-character codes that, as will be described below, provide the coordinates for the plot points that, along with the line segments, make up the drawings. Of course, such instructions do not have to appear on a card such as the one illustrated in FIGS. 5 and 6. They may be simply printed on a piece of paper or provided electronically, such as via the Internet and a computer screen.

With reference to FIG. 5, the first character of the coordinates refers to a letter that should appear in the direction window 32 (FIG. 2) of the device. The second character of the coordinates refers to the tape measure number that should appear in the tape measure window 28 (FIG. 2) of the device. For example, the first coordinates on the card of FIG. 6, indicated at 108, feature the letter “B” and the number “12”. The second coordinates 110, feature the letter “C” and the number “114.” As will now be explained with reference to FIGS. 7a-7e, the device is configured using these coordinate sets to plot out the points of the drawing in accordance with an embodiment of the method of the present invention.

The process is begun by marking an initial plot point in chalk on a surface. This point is illustrated at 120 in FIG. 7a. As illustrated in FIG. 7a, the chalk drawing device 12 is next positioned on the surface so that the initial point 120 is viewable in the point viewing window 93 of the device and the leading tab 56 is pointed away from the user in a direction that is perpendicular to both the imaginary top and bottom edges, and parallel to the imaginary side edges, of what will be the completed drawing. The letter “A” appears in the direction window 32 of the device while the number “1” appears in the tape measure window 28. Note that the tape measure pull tab (68 in FIG. 2) has been omitted from FIGS. 7a, 7c and 7d for clarity.

Assuming that the recipe card gives the first set of coordinates as “A” and “27”, the tape measure 64 is extended out of the device 12, as illustrated in FIG. 7b, until the number “27” appears in the tape measure window 28 of the device. A second plot point 122 is made in chalk on the surface through the circular opening (72 in FIGS. 1 and 2) of the tape measure pull tab 68. The tape measure 64 is automatically retracted into the device 12 when the tape retraction button 74 is pressed by the user. A line 124 is drawn on the surface in chalk between the points 120 and 122, as illustrated in FIG. 7c.

As illustrated in FIG. 7c, the device 12 is next positioned so that the point 122 is seen through point viewing window 93 and the V-shaped notch 54 of the trailing alignment tab 52 is aligned with line 124.

As illustrated in FIG. 7d, the housing cover 14 (and thus mounting plate 16 of FIG. 1) of the device 12 is rotated with respect to the base 18 via handle portion 22. Assuming that the second coordinate set on the card lists the coordinates “B” and “15”, the housing cover 14 is rotated until the letter “B” appears in direction window 32. At this time, the number “1” appears in the tape measure viewing window 28 since the tape measure was retracted.

Next, as illustrated in FIG. 7e, the tape measure 64 is extended until the number “15” appears in the tape measure window 28 of the device 12. A third plot point 126 is made in chalk on the surface through the circular opening (72 in FIGS. 1 and 2) of the tape measure pull tab 68. A line is then drawn on the surface in chalk between the points 122 and 126. The process is then repeated to draw the remaining plot points and line segments until the chalk drawing is completed.

The present invention therefore provides a chalk drawing device and method where a virtually unlimited variety of drawings may be created through the provision of “recipes” via recipe cards or the like. The device is simple to use so that it may be enjoyed by children of nearly all ages, and even by adults.

What is claimed is:

1. A device for creating a chalk drawing on a surface comprising:
a) a base adapted to rest on the surface;
b) a housing cover rotatably connected to the base;
c) a direction indicator indicating a rotational position of the housing cover with respect to the base;
d) a tape measure assembly connected to the housing cover, said tape measure assembly including a tape measure that may be moved between extended and contracted conditions, said tape measure also including a distal end portion; where a position of the distal end portion of the tape measure and a rotational position of the housing cover with respect to the base establish coordinates for a plot point of the chalk drawing.

2. The device of claim 1 wherein the base is round and the direction indicator includes a plurality of directional characters positioned about a circumference of the base and a direction window passing through the housing cover through which a selected one of the characters may be viewed, said selected one of the characters corresponding to a rotational position of the housing cover with respect to the base.

3. The device of claim 2 wherein the characters are letters.

4. The device of claim 2 wherein the tape measure features a plurality of characters and the housing cover includes a tape measure window through which a selected one of the characters may be viewed, said selected one of the characters corresponding to an extended condition of the tape measure.

5. The device of claim 1 wherein the tape measure features a plurality of characters and the housing cover includes a tape measure window through which a selected one of the characters may be viewed, said selected one of the characters corresponding to an extended condition of the tape measure.

6. The device of claim 4 wherein the characters are numbers.

7. The device of claim 1 further comprising a mounting plate attached to the housing cover with said tape measure assembly mounted to the mounting plate.

8. The device of claim 1 further comprising a point viewing window formed in the housing cover and generally aligned with a rotational axis about which the housing cover rotates with respect to the base.

9. The device of claim 1 wherein further comprising a tape measure brake slidably attached to the housing cover and movable between a position where it engages the tape measure to prevent it from retracting from a selected extended condition to the retracted condition and a position where the tape measure is released and free to retract into the housing cover.

10. The device of claim 9 further comprising a spring urging the tape measure brake into the position where it engages the tape measure to prevent it from retracting and a retraction button mounted in the housing cover for sliding the tape measure brake against the urging of the spring.

11. The device of claim 10 wherein the spring is a coil spring.

12. The device of claim 9 wherein the tape measure assembly includes a tape measure housing and the tape measure brake includes a flange portion that engages the tape measure housing with the tape measure positioned therebetween to prevent it from retracting into the tape measure housing.

13. The device of claim 1 wherein the base includes leading tab and a trailing alignment tab.

14. The device of claim 13 wherein the leading tab features a triangular shape and the trailing alignment tab includes a V-shaped notch.

15. The device of claim 1 further comprising a ratchet arm having a proximal end attached to the housing cover and a distal end that features a projection, said base including a plurality of detents that are individually engaged by the projection of the ratchet arm.

16. The device of claim 1 wherein the distal end portion of the tape measure includes a pull tab featuring an opening through which the plot point may be marked.

17. A method for creating a chalk drawing on a surface comprising the steps of:
a) providing a chalk drawing device including a base, a housing cover rotatably connected to the base, a retractable tape measure having a distal end portion connected to the housing cover, and a point viewing window;
b) marking a first plot point of the drawing on the surface with chalk;
c) positioning the chalk drawing device over the first plot point so that the first plot point is viewable through the point viewing window of the device;
d) selecting a rotational position of the housing cover with respect to the base;
e) moving the tape measure from a retracted to condition to a selected extended condition;
f) marking a second plot point of the drawing on the surface with chalk; and
g) drawing a line between the first and second plot points on the surface with chalk.

18. The method of claim 17 wherein steps d) and e) are performed with the aid of a recipe card.

19. The method of claim 17 wherein the device includes a triangular shaped leading tab that is pointed away from a user in a direction that is perpendicular to both imaginary top and bottom edges of the drawing and parallel to imaginary side edges the drawing.

20. The method of claim 17 wherein the device includes a trailing alignment tab featuring a V-shaped notch and the V-shaped notch is positioned in alignment with a previously drawn line segment.
